(19) United States
(12) Patent Application Publication
(10) Pub. No.: US 2026/0252040 A1
(43) Pub. Date: Aug. 27, 2026

(54) POWER GRID CONTROL MODEL TRAINING METHOD, SYSTEM, COMPUTER DEVICE, AND STORAGE MEDIUM

(71) Applicant: CHINA ELECTRIC POWER RESEARCH INSTITUTE, Beijing (CN)

(72) Inventors: Dapeng LI, Beijing (CN); Lixin LI, Beijing (CN); Yunhao HUANG, Beijing (CN); Lei TAO, Beijing (CN); Jiaqi WANG, Beijing (CN); Yadi LUO, Beijing (CN); Fangchun DI, Beijing (CN); Xuri SONG, Beijing (CN); Can CUI, Beijing (CN); Cong FU, Beijing (CN); Nan YANG, Beijing (CN); Yupeng HUANG, Beijing (CN); Shuzhou WU, Beijing (CN); Ling YU, Beijing (CN)

(73) Assignee: CHINA ELECTRIC POWER RESEARCH INSTITUTE, Beijing (CN)

(21) Appl. No.: 18/872,668

(22) PCT Filed: Aug. 15, 2024
(86) PCT No.: PCT/CN2024/112395

§ 371 Date: Dec. 6, 2024

(30) Foreign Application Priority Data
Jul. 3, 2023 (CN) 202310803693.7

(51) Int. Cl. G05B 13/02; H02J 13/12; H02J 103/30

(52) U.S. Cl. CPC G05B 13/0265; H02J 13/12; H02J 2103/30

(57) ABSTRACT

A power grid control model training method, a computer device, and a storage medium are provided. The method includes: acquiring and grouping power grid control model training data to obtain a plurality of training data sets; training, according to one-to-one correspondences between the training data sets and learning bodies, a plurality of preset learning bodies in parallel through the plurality of training data sets to obtain a plurality of execution bodies; wherein when training the learning bodies through the training data sets, a training data set is divided into a plurality of training data units, training effects of the training data units are acquired to obtain a shared training data unit, and the shared training data unit is shared with training data sets except a training data set including the shared training data unit; and finally, combining the plurality of execution bodies to obtain a power grid control model.

### CROSS-REFERENCE TO RELATED APPLICATIONS

This application is based on and claims priority to Chinese patent application No. 202310803693.7 filed on Jul. 3, 2023, the content of which is hereby incorporated by reference in its entirety.

### TECHNICAL FIELD

The present invention pertains to the field of power automation, and relates to a power grid control model training method, a system, a computer device, and a storage medium.

### BACKGROUND

Under the background of the development of new power systems, power grid control is faced with comprehensive analysis and uniform calculation requirements of massive data. From the perspective of technical development, new technologies, such as big data, cloud computing, and artificial intelligence, have entered a stage of rapid development, and by massive data inputs, data-driven methods compensate for the insufficiency of model-driven methods, which can effectively solve the problems of power grids such as non-linearity, non-continuity, uncertainty and randomness. However, at present the application of artificial intelligence technology in the power grid still have limitations, and there are problems such as poor model interpretability and unstable results of analysis and prediction, which makes it difficult to meet the requirements for stable, reliable, and safe operation of the power grid control system. This is because of the existence of risks in large-scale application of artificial intelligence technology to the power grid without accurate and complete data. Therefore, data-centric artificial intelligence (AI) technology has become a trend of development in various industries. In the data-centric method, it is considered that AI has reached a point where data is more important than models. If AI is considered to be a system having movable components, the model should be kept relatively fixed, and the attention should be focused on fine-tuning the model by using high quality data rather than continuously promoting marginal improvement of the model.

Although massive data resources have been accumulated from the operation of the power grids, the value density of big data of the power grid control is low, and there is less high quality sample data meeting the training of specific service models. Especially, normalized operation data accounts for the majority, while data having special features such as data of exceptions or faults is less, and the data quality is lower, which result in problems of imbalanced samples or small samples in some machine learning tasks, thus affecting the training process of AI model-based power grid control models and the prediction effect after release. After checking and cleaning processing on the big data of power grid control, data quality is improved. However, data checking is mostly based on simplified checking rules, and data cleaning is mostly based on equivalence or approximation calculation methods, which cannot ensure that the data quality meets the training requirements of all artificial intelligence service models. In addition, distributed parallel computing technology is generally used for big data, while memory computing technology is generally used for machine learning, such that big data cannot be directly loaded into the memory for training the machine learning models. Therefore, in the case where data quality, data balance, etc., cannot be completely ensured, how to use massive control data resources to improve, as much as possible, the training effect of a power grid control model and the prediction performance after the release of the power grid control model is currently an urgent problem to be solved.

### SUMMARY

An objective of the present invention is to overcome the above defects in the prior art and to provide a power grid control model training method, a system, a computer device, and a storage medium.

To achieve the above objective, the present invention is implemented by using the following technical solutions.

According to a first aspect of the present invention, a power grid control model training method is provided, which includes the following operations. Power grid control model training data are acquired and grouped to obtain a plurality of training data sets, and preset learning bodies are trained in parallel through the multiple training data sets according to one-to-one correspondences between the training data sets and learning bodies to obtain multiple execution bodies. When the learning bodies are trained through the training data sets, a current training data set is divided into multiple training data units, a current learning body is trained through the multiple training data units in sequence, and training effects of the multiple training data units on the current learning body are acquired; and a training data unit with a training effect meeting a preset training effect requirement is taken as a shared training data unit, and the shared training data unit is shared with training data sets except a training data set comprising the shared training data unit. The multiple learning bodies are multiple Artificial Intelligence (AI) models for a power grid control service constructed according to a power grid control requirement. The multiple execution bodies are combined to obtain a power grid control model. The combining includes taking inputs to the multiple execution bodies together as an input to the power grid control model, and fusing outputs of the multiple execution bodies into an output of the power grid control model.

Optionally, the operation that the multiple preset learning bodies are trained in parallel through the multiple training data sets to obtain the multiple execution bodies includes the following operations. The multiple preset learning bodies are trained in parallel through the multiple training data sets according to the one-to-one correspondences between the training data sets and the learning bodies and in combination with preset evaluation bodies corresponding one-to-one to the learning bodies. After the training is completed, preset prediction indexes of the learning bodies are acquired via the evaluation bodies, and learning bodies with preset prediction indexes meeting a preset training requirement for the preset prediction indexes are taken as the execution bodies.

Optionally, the multiple AI models for the power grid control service are constructed via two or more machine learning algorithms or artificial intelligence algorithms.

Optionally, the multiple AI models for the power grid control service execute a same type of power grid control service or complementary power grid control services.

Optionally, the method further includes the following operations. First preset prediction index values of the execution bodies in the power grid control model for power grid control model real-time data are periodically acquired. When a first preset prediction index value of an execution body in the power grid control model fails to meet a preset requirement of first preset prediction index values for a consecutive preset number of times, the execution body is removed from the power grid control model, or the execution body is retrained through the power grid control model training data.

Optionally, the method further includes the following operations. Power grid control model real-time data of an execution body with a second preset prediction index value less than a preset prediction requirement of second preset prediction index values is acquired to obtain data with a key feature; and the data with the key feature is shared as the power grid control model training data to the training data sets to obtain multiple updated training data sets. The multiple preset learning bodies are trained in parallel through the multiple updated training data sets according to one-to-one correspondences between the updated training data sets and the learning bodies to obtain multiple updated execution bodies.

Optionally, before the multiple preset learning bodies are trained in parallel through the multiple updated training data sets, the method further includes the following operations. Relevant data of the data with the key feature are acquired, and the relevant data of the data with the key feature is shared as the power grid control model training data to the updated training data sets. The relevant data includes: data with a temporal relationship to the data with the key feature, data of a device with a topological connection relationship to a device corresponding to the data with the key feature, and data with a service logic relationship to the data with the key feature.

Optionally, before the multiple preset learning bodies are trained in parallel through the multiple updated training data sets, the method further includes the following operations. A feature of the data with the key feature is extracted through a data feature analysis method to obtain an extracted feature. An optimization approach is acquired, and power grid control model training data in the updated training data sets or the multiple learning bodies are optimized according to the optimization approach. The optimization approach is obtained according to the extracted feature in combination with a test evaluation effect of the learning bodies, an inference effect of the execution bodies and service domain knowledge. The test evaluation effect of the learning bodies and the inference effect of the execution bodies are obtained in a manual analysis manner.

Optionally, the optimization approach includes one or more of: changing a data range of the power grid control model training data, changing a data dimension of the power grid control model training data, changing a data checking rule of the power grid control model training data, changing a data cleaning rule of the power grid control model training data, and changing a number of the learning bodies.

Optionally, the outputs of the multiple execution bodies are fused into the output of the power grid control model, which includes the following operations. Weighted superposition of the outputs of the multiple execution bodies according to the preset weighting coefficients of the execution bodies are taken as the output of the power grid control model. Alternatively, the outputs of the multiple execution bodies are processed according to a scoring method to obtain the output of the power grid control model.

Optionally, the method further includes the following operations. The preset weighting coefficients of the execution bodies are dynamically adjusted at a dynamic frequency. The preset weighting coefficients of the execution bodies are adjusted in the following manner. Prediction accuracy rates or prediction precision rates of the execution bodies are acquired. The weighting coefficients of the execution bodies are adjusted according to the prediction accuracy rates or the prediction precision rates of the execution bodies by using a factor analysis method, a principal component analysis method, an Analytic Hierarchy Process (AHP) method, a precedence graph method, an entropy method, a Criteria Importance Through Intercriteria Correlation (CRITIC) weighting method, an independence weighting method, or an information amount weighting method.

According to a second aspect of the present invention, a power grid control model training system is provided, which includes a data acquisition module, a model training module and a model assembling module. The data acquisition module is configured to acquire and group power grid control model training data to obtain multiple training data sets. The model training module is configured to train, according to one-to-one correspondences between the training data sets and learning bodies, multiple preset learning bodies in parallel through the multiple training data sets to obtain multiple execution bodies. When the learning bodies are trained through the training data sets, a current training data set is divided into multiple training data units, a current learning body is trained through the multiple training data units in sequence, and training effects of the multiple training data units on the current learning body are acquired; and a training data unit with a training effect meeting a preset training effect requirement is taken as a shared training data unit, and the shared training data unit is shared with training data sets except a training data set comprising the shared training data unit, wherein the multiple learning bodies are multiple Artificial Intelligence (AI) models for a power grid control service constructed according to a power grid control requirement. The model assembling module is configured to combine the multiple execution bodies to obtain a power grid control model. The combining includes taking inputs to the multiple execution bodies together as an input to the power grid control model, and fusing outputs of the multiple execution bodies into an output of the power grid control model.

Optionally, the operation that the multiple preset learning bodies are trained in parallel through the multiple training data sets to obtain the multiple execution bodies includes the following operations. The multiple preset learning bodies are trained in parallel through the multiple training data sets according to the one-to-one correspondences between the training data sets and the learning bodies and in combination with preset evaluation bodies corresponding one-to-one to the learning bodies. After the training is completed, preset prediction indexes of the learning bodies are acquired via the evaluation bodies, and learning bodies with preset prediction indexes meeting a preset training requirement for the preset prediction indexes are taken as the execution bodies.

Optionally, the system further includes a retraining module. The retraining module is configured to: acquire power grid control model real-time data of an execution body with a second preset prediction index value less than a preset prediction requirement of second preset prediction index values to obtain data with a key feature; share the data with the key feature as the power grid control model training data to the training data sets to obtain multiple updated training data sets; train, according to one-to-one correspondences between the updated training data sets and the learning bodies, the multiple preset learning bodies in parallel through the multiple updated training data sets to obtain multiple updated execution bodies; and replace the multiple execution bodies in the power grid control model with the multiple updated execution bodies.

Optionally, before the multiple preset learning bodies are trained in parallel through the multiple updated training data sets, the following operations are included. A feature of the data with the key feature is extracted through a data feature analysis method to obtain an extracted feature. An optimization approach is acquired, and power grid control model training data in the updated training data sets or the multiple learning bodies is optimized according to the optimization approach. The optimization approach is obtained in a manual analysis manner according to the extracted feature in combination with service domain knowledge.

According to a third aspect of the present invention, a computer device is provided. The computer device includes a memory, a processor and a computer program stored in the memory and executable on the processor. The processor, when executing the computer program, implements the operations of the above power grid control model training method.

According to a fourth aspect of the present invention, a computer-readable storage medium is provided. The computer-readable storage medium has a computer program stored therein. When the computer program is executed by a processor, the operations of the above power grid control model training method are implemented.

Compared with the prior art, the present invention has the following beneficial effects.

According to the power grid control model training method of the present invention, power grid control model training data is acquired and grouped, such that grouped training is performed on multiple learning bodies to obtain multiple execution bodies. Then the multiple execution bodies are combined to obtain a power grid control model. The features of power grid control model training data in a big data environment, such as a large data volume, numerous data types, and long-period historical data, are fully taken into consideration. By parallel training and parallel prediction, exchange of quantity for quality is realized, which greatly reduces the time required for model training, and improves the training effect and the prediction effect of the power grid control model. In addition, with respect to the problems of few high quality samples, imbalanced samples, or small samples of the power grid control model training data, the training data set is divided into multiple training data units. High quality samples (i.e., shared training data units) are selected based on the training effect of the training data units and a preset training effect requirement, and the shared training data units are shared with the training data sets, so that the shared learning of the high quality sample data is realized, thereby effectively improving the training effect, and further reducing the training time of the power grid control model under the condition of big data.

### BRIEF DESCRIPTION OF THE DRAWINGS

The drawings are here incorporated into and constitute a part of the specification. The drawings show embodiments consistent with the present application, and are used to illustrate the technical solutions of the present application together with the specification.

FIG. 1 is a flowchart of a power grid control model training method according to an embodiment of the present invention.

FIG. 2 is a diagram of a principle of a power grid control model training method according to an embodiment of the present invention.

FIG. 3 is a detailed flowchart of a power grid control model training method according to an embodiment of the present invention.

FIG. 4 is a diagram of a principle of parallel training of learning bodies according to an embodiment of the present invention.

FIG. 5 is a diagram of a principle of weight coefficient correction for execution bodies according to an embodiment of the present invention.

FIG. 6 is a structural block diagram of a power grid control model training system according to an embodiment of the present invention.

### DETAILED DESCRIPTION

In order to enable those skilled in the art to better understand the solutions of the present invention, the technical solutions in the embodiments of the present invention would be described clearly and completely below with reference to the drawings in the embodiments of the present invention. It is apparent that the described embodiments are merely some, rather than all, of the embodiments of the present invention. All other embodiments obtained by those skilled in the art based on the embodiments of the present invention without creative efforts shall still fall within the scope of protection of the present invention.

It should be noted that the terms “first,” “second,” and so on in the description and claims of the present invention and in the above drawings are used to distinguish similar objects and are not necessarily used to describe a specific sequence or chronological order. It should be understood that the data used in this way is interchangeable where appropriate so that the embodiments of the present invention described herein can be implemented in orders other than those illustrated or described herein. In addition, the terms “comprise/include” and “have” and any variations thereof are intended to cover non-exclusive inclusions. For example, processes, methods, systems, products, or devices including a series of operations or units are not limited to those operations or units that are explicitly listed, but may include other operations or units not explicitly listed or inherent to these processes, methods, products, or devices.

The present invention would be described in further detail below with reference to the drawings.

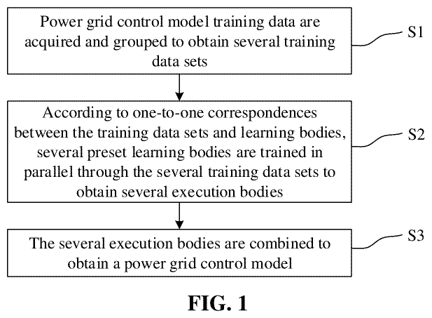

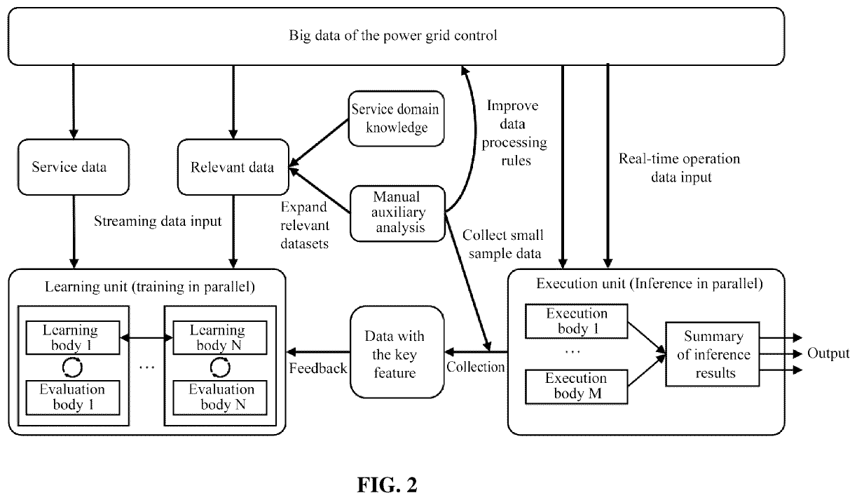

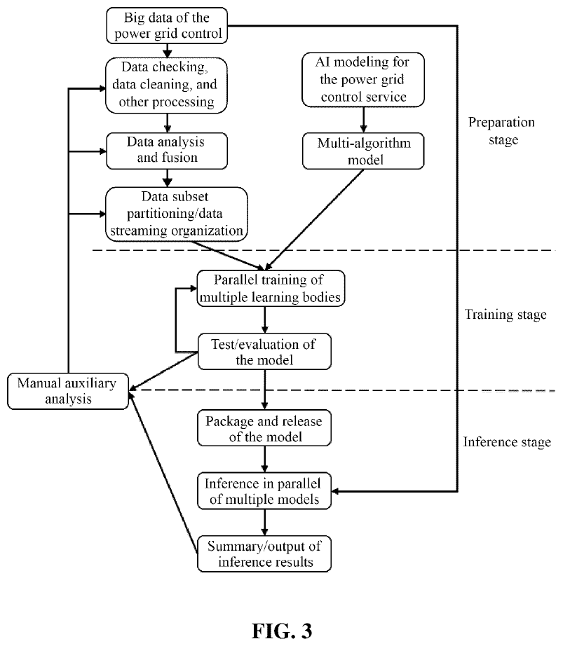

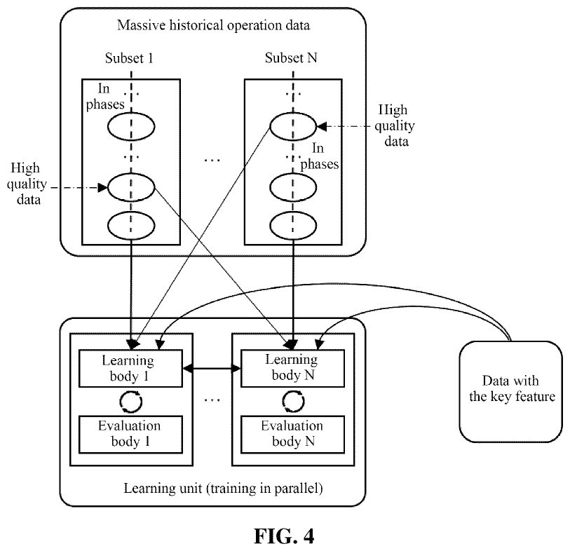

Referring to FIG. 1 to FIG. 4, in an embodiment of the present invention, a power grid control model training method is provided. By means of parallel training and parallel prediction, parallel training and prediction of a power grid control model is achieved based on control big data, improving the training and prediction effects of the power grid control model under the condition of data uncertainty, and realizing the exchange of quantity for quality in the big data environment. Specifically, the power grid control model training method includes the following operations.

S1: Power grid control model training data are acquired and grouped to obtain multiple training data sets.

S2: According to one-to-one correspondences between the training data sets and learning bodies, multiple preset learning bodies are trained in parallel through the multiple training data sets to obtain multiple execution bodies.

When the learning bodies are trained through the training data sets, a current training data set is divided into multiple training data units, a current learning body is trained through the multiple training data units in sequence, and training effects of the multiple training data units on the current learning body are acquired; and a training data unit with a training effect meeting a preset training effect requirement is taken as a shared training data unit, and the shared training data unit is shared with training data sets except a training data set comprising the shared training data unit. The multiple learning bodies are multiple Artificial Intelligence (AI) models for a power grid control service constructed according to a power grid control requirement.

S3: The multiple execution bodies are combined to obtain a power grid control model.

The combining includes taking inputs to the multiple execution bodies together as an input to the power grid control model, and fusing outputs of the multiple execution bodies into an output of the power grid control model.

Control big data is generally a collection of data associated with power grid operation and collected based on a big data platform of power grid control, and includes all information records associated with power grid dispatching and operation, such as power grid model data, monitoring data, alarm data, and operation records. The data scale of the control big data is consistent with the feature of 5V of the big data, and the big data platform technology and related big data algorithms are applied in the processes of acquisition, processing, etc., of the control big data. The power grid control model training data may be acquired from the control big data based on different control service requirements. Specifically, service data and relevant data may be selected according to specific requirements of AI models for a power grid control service, thus forming a collection of the power grid control model training data required for the power grid control model training through the data fusion technology.

Specifically, due to the large volume of historical operation data in the big data of the power grid control, it is difficult to accurately evaluate the data quality and balance. In order to fully take advantage of the features of big data such as the massive volume and numerous types, the massive power grid control model training data is divided into subsets and respectively input into different learning bodies for learning. Furthermore, different training data sets may be allowed to overlap.

Specifically, the number of learning bodies may be dynamically increased according to the amount of data to be learned, the time requirement for learning, etc. The rapid deployment and the elastic expansion and contraction of the learning bodies may be performed in a containerized deployment-based manner.

Specifically, in the specific training process of the learning body, the learning process of the learning body may be in phases. That is, the training data set is divided into multiple training data units for phased learning. For example, the simplest way is to divide the training data set according to the time of the data, and the training data units are respectively used for learning. In addition, the learning effects of the training data units are determined according to the training effects of the training data units for the current learning body, and a training data unit with a better learning effect may be shared with other training data sets to improve the learning effects of other learning bodies.

In sum, according to the power grid control model training method of the present invention, power grid control model training data is acquired and grouped, such that the grouped training is performed on multiple learning bodies to obtain multiple execution bodies. Then the multiple execution bodies are combined to obtain a power grid control model. The features of power grid control model training data in a big data environment, such as a large data volume, numerous data types, and long-period historical data, are fully taken into consideration. By parallel training and parallel prediction, exchange of quantity for quality is realized, which greatly reduces the time required for model training, and improves the training effect and the prediction effect of the power grid control model. In addition, with respect to the problems of few high quality samples, imbalanced samples, or small samples of the power grid control model training data, the training data set is divided into multiple training data units. High quality samples (i.e., shared training data units) are selected based on the training effect of the training data units and a preset training effect requirement, and the shared training data units are shared with the training data sets, so that the shared learning of the high quality sample data is realized, thereby effectively improving the training effect, and further reducing the training time of the power grid control model under the condition of big data.

In a possible embodiment, the operation that the multiple preset learning bodies are trained in parallel through the multiple training data sets to obtain the multiple execution bodies includes the following operations. The multiple preset learning bodies are trained in parallel through the multiple training data sets according to the one-to-one correspondences between the training data sets and the learning bodies and in combination with preset evaluation bodies corresponding one-to-one to the learning bodies. After the training is completed, preset prediction indexes of the learning bodies are acquired via the evaluation bodies, and learning bodies with preset prediction indexes meeting a preset training requirement for the preset prediction indexes are taken as the execution bodies.

Specifically, the preset prediction indexes of the learning bodies are acquired after the training is completed. The preset prediction indexes may be prediction accuracy rates or prediction precision rates. The preset prediction indexes of the learning bodies may be acquired by providing the test sets. Optionally, a respective evaluation body may be provided for each learning body to evaluate the learning effect of the learning body, and an evaluation result of the evaluation body affects the fusion process of outputs of the execution body. Optionally, the learning and evaluation is a process of cyclic feedback. That is, the training and testing may be cyclically iterated until a certain number of learning bodies meet the requirements of the control services, that is, the preset prediction indexes of these learning bodies meet the requirement of a preset threshold. Then, parameters in the learning body are fixed, and the learning body is packaged together with the required environment and dependence into an execution body.

In addition, the training may be a continuous process. For example, the training of the learning body may be continued after the power grid control model is released. Various version of the learning body may be managed via version management, and the power grid control model may be upgraded and released according to the prediction condition of the control services.

The evaluation body is a module that evaluates the learning effect of the learning body. The evaluation body and the learning body together serve as a learning unit. The evaluation result of the evaluation body affects a subsequent application of the execution body obtained based on training the learning body, for example, affecting a weight of the corresponding execution body.

During the training of the learning body, a process of cyclic feedback is formed between the learning of the learning body and the evaluation of the evaluation body, and the learning effect of the learning body is improved based on the evaluation of the evaluation body.

In a possible embodiment, the multiple AI models for the power grid control service are constructed via two or more machine learning algorithms or artificial intelligence algorithms. Specifically, the learning bodies are modeled by using different algorithms, which can effectively reduce the impact of the algorithms on the learning effects of the learning bodies.

In a possible embodiment, the multiple AI models for the power grid control service may execute the same type of power grid control service or complementary power grid control services.

Specifically, the execution body is obtained by packaging and releasing the learning body, and multiple execution bodies are combined to perform parallel prediction to obtain the power grid control model. Depending on the design of the AI models for the power grid control service, if the AI models for the power grid control service execute the same type of power grid control service, the execution bodies obtained from packaging the learning body execute the same type of power grid control service, so as to improve the accuracy rate of prediction via group decision. If the AI models for the power grid control service execute complementary power grid control services, the execution bodies obtained from packaging the learning body execute complementary power grid control services, so as to perform prediction analysis from multiple perspectives, improving the accuracy rate of prediction.

For executing the same type of power grid control service (e.g., bus load prediction), one AI model for the power grid control service is formed by means of modeling and training performed through a Long Short-Term Memory (LSTM) algorithm, and another AI model for the power grid control service is formed by means of modeling and training performed through a Back Propagation (BP) neural network algorithm. The two AI models for the power grid control service are different only in terms of algorithms, but both perform the task of bus load prediction, and are therefore referred to as the AI model for the power grid control service executing the same type of power grid control service. In another way of understanding, execution bodies formed by using the same algorithm and different training data are also different, but still execute tasks of the same type. The final combination of the execution bodies is relatively flexible, and the combination can be dynamically adjusted according to the power grid control services.

For executing complementary power grid control services, for example, one AI model for the power grid control service predicts which devices in the power grid may be faulty and predicts the probability and time of occurrence of the fault; another AI model for the power grid control service predicts the range of influence of the fault of the device; still another AI model for the power grid control service predicts a recovery time after the fault of the device. The three power grid control services have corresponding emphasis and are overlapped, and may be used as complementary sub-tasks of “analysis of influence of power grid device fault” when combined.

In actual prediction, power grid control model real-time data provided by a big data platform is input into the execution bodies respectively, execution results of the execution bodies are fused to obtain a final prediction result, and the final prediction result is output.

In a possible embodiment, the power grid control model training method further includes the following operations. First preset prediction index values of the execution bodies in the power grid control model for power grid control model real-time data are periodically acquired. When a first preset prediction index value of an execution body in the power grid control model fails to meet a preset requirement of first preset prediction index values for a consecutive preset number of times, the execution body is removed from the power grid control model, or the execution body is retrained through the power grid control model training data.

Specifically, as time goes on, whether a previous prediction result is correct (or the accuracy rate) can be verified by the actual operation of the power grid. Taking the bus load prediction as an example, indexes, such as the accuracy rate and the precision rate, predicted by each execution body may be calculated by comparing predicted data with actually measured data of the operation of the power grid, and each execution body can further be dynamically adjusted according to a respective calculation result of the indexes of the execution body. For example, an execution body that consecutively fails to meet the preset prediction accuracy rate threshold three times may be removed from the power grid control model, so as to ensure that the prediction result of the power grid control model is not affected by the execution bodies with lower accuracy rates, and ensures the accuracy of the prediction. In addition, such execution bodies may also be adjusted by means of retraining.

In a possible embodiment, the power grid control model training method further includes the following operations. Power grid control model real-time data of an execution body with a second preset prediction index value less than a preset prediction requirement of second preset prediction index values is acquired to obtain data with a key feature; and the data with the key feature is shared as the power grid control model training data to the training data sets to obtain multiple updated training data sets. The multiple preset learning bodies are trained in parallel through the multiple updated training data sets according to one-to-one correspondences between the updated training data sets and the learning bodies to obtain multiple updated execution bodies.

Specifically, in the parallel prediction process of the execution bodies, thresholds of indexes such as the accuracy rate are set as power grid control model real-time data acquisition feedback thresholds. In the case that the indexes, such as the accuracy rate or the precision rate, of the execution bodies do not reach the corresponding thresholds, corresponding power grid control model real-time data is automatically collected, and fed back as new power grid control model training data to the learning bodies for learning, further improving the learning effect of the learning bodies.

In a possible embodiment, before the multiple preset learning bodies are trained in parallel through the multiple updated training data sets, the method further includes the following operations. Relevant data of the data with the key feature are acquired, and the relevant data of the data with the key feature is shared as the power grid control model training data to the updated training data sets.

Specifically, according to different service scenarios, in addition to the acquisition of the data with the key feature, relevant data of the data with the key feature may also be acquired, for example, relevant data having a temporal logic relationship or other relationships with the data with the key feature. In an example of recent bus load prediction, data of the current day, data of the preceding day, and data of the following day may be collected, and fed back as new power grid control model training data to the learning bodies.

The relevant data includes: data with a temporal relationship to the data with the key feature, data of a device with a topological connection relationship to a device corresponding to the data with the key feature, and data with a service logic relationship to the data with the key feature.

In a possible embodiment, before the multiple preset learning bodies are trained in parallel through the multiple updated training data sets, the method further includes the following operations. A feature of the data with the key feature is extracted through a data feature analysis method to obtain an extracted feature. An optimization approach is acquired, and power grid control model training data in the updated training data sets or the multiple learning bodies are optimized according to the optimization approach. The optimization approach is obtained according to the extracted feature in combination with a test evaluation effect of the learning bodies, an inference effect of the execution bodies and service domain knowledge. The test evaluation effect of the learning bodies and the inference effect of the execution bodies are obtained in a manual analysis manner.

The domain knowledge refers to knowledge in a specific and specialized discipline or domain. The domain knowledge in the present invention refers to professional knowledge associated with power grid control, and includes constraints on power grid operation, relevant service rules, etc.

Specifically, the feature of the data with the key feature is extracted by using the data feature analysis method, and is fed back for manual auxiliary analysis. By means of manual analysis, the cause of a decrease in indexes (such as the prediction accuracy rate) of the execution body due to the data with the key feature is determined, and it is further analyzed on that basis whether it is required to optimize the learning body model, expand a training data range of the learning body, or the like.

The optimization approach includes one or more of: changing a data range of the power grid control model training data, changing a data dimension of the power grid control model training data, changing a data checking rule of the power grid control model training data, changing a data cleaning rule of the power grid control model training data, and changing a number of the learning bodies.

Specifically, for changing the data checking rule and the data cleaning rule of the power grid control model training data, taking the bus load prediction as an example, bus balance and plant station balance checking rules may be added. Alternatively, in the case that measurement data of low voltage level buses is absent or has a poor accuracy rate, the accuracy rate of collected measurement data may be improved by means of bypass operation, by calculating bus power using electric quantity data, or the like. For changing the data dimension of the power grid control model training data, data dimensions of the power grid control model training data may be added. Taking the bus load prediction as an example, in addition to the power grid operation measurement data, data such as meteorological data, holiday information, load types, etc., may be further added.

In a possible embodiment, the outputs of the multiple execution bodies are fused into the output of the power grid control model, which includes the following operations. Weighted superposition of the outputs of the multiple execution bodies according to the preset weighting coefficients of the execution bodies are taken as the output of the power grid control model. Alternatively, the outputs of the multiple execution bodies are processed according to a scoring method to obtain the output of the power grid control model.

Specifically, when the outputs of the multiple execution bodies are processed according to a scoring method, scoring methods that are typically used include a mean scoring method, a clustering algorithm (e.g., K-Means, Gaussian Mixture Models (GMM), etc. ,), a proximity measurement method (e.g., an abnormal data detection method based on a distance (e.g., K-Nearest Neighbors (KNN)) and density (e.g., Local Outlier Factor (LOF))), and other similar methods. In the mean scoring method, the largest value and the smallest value are typically removed, and the mean is then calculated. When there are many execution bodies, the clustering algorithm, the proximity measurement method, or the like are typically used. The clustering method includes the following operations. Predicted values of all execution bodies are divided into multiple clusters via a clustering algorithm (e.g., the K-Means algorithm), then the cluster size, the compactness, and the granularity are calculated to obtain higher intra-cluster similarity and lower inter-cluster similarity. A cluster center of the largest and most compact cluster is obtained as the output of the power grid control model.

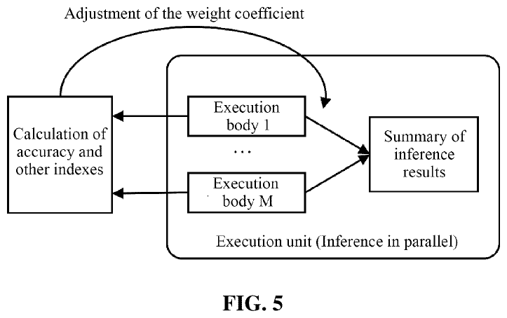

Optionally, referring to FIG. 5, the preset weighting coefficients of the execution bodies are set by the following operations. The prediction accuracy rates or the prediction precision rates of the execution bodies are acquired, and the weighting coefficients of the execution bodies are set according to the prediction accuracy rates or the prediction precision rates of the execution bodies by using a factor analysis method, a principal component analysis method, an AHP hierarchy method, a precedence graph method, an entropy method, a CRITIC weighting method, an independence weighting method, or an information amount weighting method. Optionally, the sum of the preset weighting coefficients of the execution bodies is 1.

In a possible embodiment, the power grid control model training method further includes the operation that the preset weighting coefficients of the execution bodies are dynamically adjusted at a dynamic frequency.

Specifically, the preset weighting coefficients of the execution bodies are changed dynamically. The preset weighting coefficients of the execution bodies may first be determined according to the prediction accuracy rates or the prediction precision rates of the execution bodies on a provided test set, and may then be dynamically adjusted in a subsequent parallel prediction process according to the prediction accuracy rates or the prediction precision rates of the execution bodies on the power grid control model real-time data within a certain time. For example, the weight coefficient of the execution body with a higher prediction accuracy rate may be increased, and the weight coefficient of the execution body with a lower prediction accuracy rate may be decreased. For the acquisition of the prediction accuracy rate or the prediction precision rate and the adjustment of the weight coefficients of the execution bodies, the corresponding acquisition frequency and adjustment frequency may be set according to specific service application requirements.

The following are apparatus embodiments of the present invention that may be used to perform the method embodiments of the present invention. For details not disclosed in the apparatus embodiments, reference may be made to the method embodiments of the present invention.

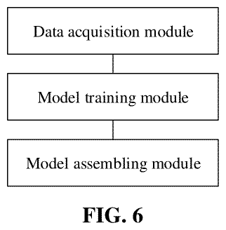

Referring to FIG. 6, in another embodiment of the present invention, a power grid control model training system is provided, which can be used to implement the above power grid control model training method. Specifically, the power grid control model training system includes a data acquisition module, a model training module, and a model assembling module. The data acquisition module is configured to acquire and group power grid control model training data to obtain several training data sets. The model training module is configured to train, according to one-to-one correspondences between the training data sets and learning bodies, several preset learning bodies in parallel through the several training data sets to obtain several execution bodies. When the learning bodies are trained through the training data sets, a current training data set is divided into several training data units, a current learning body is trained through the several training data units in sequence, and training effects of the several training data units on the current learning body are acquired; and a training data unit with a training effect meeting a preset training effect requirement is taken as a shared training data unit, and the shared training data unit is shared with training data sets except a training data set comprising the shared training data unit, wherein the several learning bodies are several Artificial Intelligence (AI) models for a power grid control service constructed according to a power grid control requirement. The model assembling module is configured to combine the several execution bodies to obtain a power grid control model. The combining includes taking inputs to the several execution bodies together as an input to the power grid control model, and fusing outputs of the several execution bodies into an output of the power grid control model.

In a possible embodiment, the operation that the several preset learning bodies are trained in parallel through the several training data sets to obtain the several execution bodies includes the following operations. The several preset learning bodies are trained in parallel through the several training data sets according to the one-to-one correspondences between the training data sets and the learning bodies and in combination with preset evaluation bodies corresponding one-to-one to the learning bodies. After the training is completed, preset prediction indexes of the learning bodies are acquired via the evaluation bodies, and learning bodies with preset prediction indexes meeting a preset training requirement for the preset prediction indexes are taken as the execution bodies.

In a possible embodiment, the several AI models for the power grid control service are constructed via two or more machine learning algorithms or artificial intelligence algorithms.

In a possible embodiment, the several AI models for the power grid control service execute a same type of power grid control service or complementary power grid control services.

In a possible embodiment, the system further includes a monitoring module. The monitoring module is configured to: periodically acquire first preset prediction index values of the execution bodies in the power grid control model for power grid control model real-time data; when a first preset prediction index value of an execution body in the power grid control model fails to meet a preset requirement of first preset prediction index values for a consecutive preset number of times, remove the execution body from the power grid control model, or retrain the execution body through the power grid control model training data.

In a possible embodiment, the system further includes a retraining module. The retraining module is configured to: acquire power grid control model real-time data of an execution body with a second preset prediction index value less than a preset prediction requirement of second preset prediction index values to obtain data with a key feature; share the data with the key feature as the power grid control model training data to the training data sets to obtain several updated training data sets; train, according to one-to-one correspondences between the updated training data sets and the learning bodies, the several preset learning bodies in parallel through the several updated training data sets to obtain several updated execution bodies; and replace the several execution bodies in the power grid control model with the several updated execution bodies.

In a possible embodiment, before the several preset learning bodies are trained in parallel through the several updated training data sets, the following operations are included. Relevant data of the data with the key feature are acquired, and the relevant data of the data with the key feature is shared as the power grid control model training data to the updated training data sets.

In a possible embodiment, before the several preset learning bodies are trained in parallel through the several updated training data sets, the following operations are included. A feature of the data with the key feature is extracted through a data feature analysis method to obtain an extracted feature. An optimization approach is acquired, and power grid control model training data in the updated training data sets or the several learning bodies is optimized according to the optimization approach. The optimization approach is obtained in a manual analysis manner according to the extracted feature in combination with service domain knowledge.

In a possible embodiment, the optimization approach includes one or more of: changing a data range of the power grid control model training data, changing a data dimension of the power grid control model training data, changing a data checking rule of the power grid control model training data, changing a data cleaning rule of the power grid control model training data, and changing a number of the learning bodies.

In a possible embodiment, the outputs of the several execution bodies are fused into the output of the power grid control model, which includes the following operations. Weighted superposition of the outputs of the several execution bodies according to the preset weighting coefficients of the execution bodies are taken as the output of the power grid control model. Alternatively, the outputs of the several execution bodies are processed according to a scoring method to obtain the output of the power grid control model.

In a possible embodiment, the power grid control model training system further includes: the preset weighting coefficients of the execution bodies are dynamically adjusted at a dynamic frequency. The preset weighting coefficients of the execution bodies are adjusted in the following manner. Prediction accuracy rates or prediction precision rates of the execution bodies are acquired. The weighting coefficients of the execution bodies are adjusted according to the prediction accuracy rates or the prediction precision rates of the execution bodies by using a factor analysis method, a principal component analysis method, an Analytic Hierarchy Process (AHP) method, a precedence graph method, an entropy method, a Criteria Importance Through Intercriteria Correlation (CRITIC) weighting method, an independence weighting method, or an information amount weighting method.

All relevant contents of the operations involved in the foregoing embodiments of the power grid control model training method may be referred to for the functional description of the functional modules corresponding to the power grid control model training system in the embodiments of the present invention, and would not be elaborated herein.

The division of the modules in the embodiments of the present invention is illustrative and is merely a logical function division, and there may be other division manners in actual implementation. In addition, the functional modules in the embodiments of the present invention may be integrated into a single processor, or may be individually physically present. Alternatively, two or more modules may be integrated into one module. The integrated modules above may be implemented in the form of hardware or in the form of software functional modules.

In another embodiment of the present invention, a computer device is provided, which includes a processor and a memory. The memory is configured to store a computer program. The computer program includes program instructions. The processor is configured to execute the program instructions stored in the computer storage medium. The processor may be a Central Processing Unit (CPU), or may be other general-purpose processors, a Digital Signal Processor (DSP), an Application Specific Integrated Circuit (ASIC), a Field-Programmable Gate Array (FPGA) or other programmable logic devices, a discrete gate or transistor logic device, a discrete hardware component, or the like, which is the computing core and the control core of the terminal, and is suitable for implementing one or more instructions. Specifically, the processor is suitable for loading and executing one or more instructions in the computer storage medium to implement the corresponding method flows or corresponding functions. The processor according to the embodiments of the present invention may be used for the operation of the power grid control model training method.

In yet another embodiment of the present invention, the present invention further provides a storage medium, which may specifically be a computer-readable storage medium (memory). The computer-readable storage medium is a memory device in a computer device, and is configured to store a program and data. It can be understood that the computer-readable storage medium herein may include a built-in storage medium in the computer device, and certainly may further include an extended storage medium supported by the computer device. The computer-readable storage medium provides a storage space in which an operating system of the terminal is stored. In addition, one or more instructions suitable for being loaded and executed by the processor are further stored in the storage space, and the instructions may be one or more computer programs (including program codes). It should be noted that the computer-readable storage medium herein may be a high-speed Random Access Memory (RAM), or may be a non-volatile memory, for example, at least one magnetic disk memory. One or more instructions stored in the computer-readable storage medium may be loaded and executed by the processor to implement the corresponding operations of the power grid control model training method in the above embodiments.

It should be apparent to those skilled in the art that the embodiments of the present invention may be provided as a method, a system, or a computer program product. Therefore, the present invention may take the form entirely of a hardware embodiment, entirely of a software embodiment, or of an embodiment combining software and hardware aspects. Moreover, the present invention may take the form of a computer program product implemented on one or multiple computer-readable storage media (which includes, but is not limited to, a magnetic disk memory, a CD-ROM, an optical memory, etc.) containing computer-readable program codes therein.

The present invention is described with reference to a flowchart and/or block diagram of a method, a device (system), and a computer program product according to an embodiment of the present invention. It should be understood that each process and/or block in the flowchart and/or block diagram, and a combination of processes and/or blocks in the flowchart and/or block diagram may be implemented by computer program instructions. These computer program instructions may be supplied to a processor of a general-purpose computer, a special-purpose computer, an embedded processing machine, or other programmable data processing device to generate a machine, such that instructions executed by the processor of the computer or other programmable data processing device generate apparatuses for implementing the functions specified in one or more processes of the flowchart and/or one or more blocks of the block diagram.

These computer program instructions may also be stored in a computer-readable memory capable of directing a computer or other programmable data processing devices to operate in a specific manner, such that the instructions stored in the computer-readable memory produce a manufactured article including an instruction apparatus that implements the functions specified in one or more processes of the flowchart and/or one or more blocks of the block diagram.

These computer program instructions may also be loaded onto a computer or other programmable data processing devices, so as to perform a series of operations on the computer or other programmable devices to generate computer-implemented processing, so that the instructions executed on the computer or other programmable devices provide operations for implementing the functions specified in one or more processes of the flowchart and/or one or more blocks of the block diagram.

Finally, it should be noted that the above embodiments are merely provided for describing, instead of limiting, the technical solutions of the present invention. Although the present invention has been described in detail with reference to the embodiments above, those of ordinary skill in the art should understand that any modifications or equivalent replacements made to the specific embodiments without departing from the spirit and scope of the present invention shall still fall within the scope of protection of the claims of the present invention.

1. A power grid control model training method, comprising:
acquiring and grouping power grid control model training data to obtain a plurality of training data sets, wherein the power grid control model training data is acquired from control big data based on different control service requirements, and the control big data big data is a collection of data associated with power grid operation, and comprises power grid model data, monitoring data, alarm data, and operation records;
training, according to one-to-one correspondences between the training data sets and learning bodies, a plurality of preset learning bodies in parallel through the plurality of training data sets to obtain a plurality of execution bodies; wherein when training the learning bodies through the training data sets, a current training data set is divided into a plurality of training data units, a current learning body is trained through the plurality of training data units in sequence, and training effects of the plurality of training data units on the current learning body are acquired; and a training data unit with a training effect meeting a preset training effect requirement is taken as a shared training data unit, and the shared training data unit is shared with training data sets except a training data set comprising the shared training data unit, wherein the plurality of learning bodies are a plurality of Artificial Intelligence (AI) models for a power grid control service constructed according to a power grid control requirement; and
combining the plurality of execution bodies to obtain a power grid control model, wherein the combining comprises taking inputs to the plurality of execution bodies together as an input to the power grid control model, and fusing outputs of the plurality of execution bodies into an output of the power grid control model,
wherein the power grid control service is bus load prediction or power grid device fault prediction.

2. The power grid control model training method according to claim 1, wherein training the plurality of preset learning bodies in parallel through the plurality of training data sets to obtain the plurality of execution bodies comprises:
training, according to the one-to-one correspondences between the training data sets and the learning bodies, the plurality of preset learning bodies in parallel through the plurality of training data sets in combination with preset evaluation bodies corresponding one-to-one to the learning bodies; and after the training is completed, acquiring preset prediction indexes of the learning bodies via the evaluation bodies, and taking learning bodies with preset prediction indexes meeting a preset training requirement for the preset prediction indexes as the execution bodies.

3. The power grid control model training method according to claim 1, wherein the plurality of AI models for the power grid control service are constructed via two or more machine learning algorithms or artificial intelligence algorithms.

4. The power grid control model training method according to claim 1, wherein the plurality of AI models for the power grid control service execute a same type of power grid control service or complementary power grid control services.

5. The power grid control model training method according to claim 1, further comprising:
periodically acquiring first preset prediction index values of the execution bodies in the power grid control model for power grid control model real-time data; and
when a first preset prediction index value of an execution body in the power grid control model fails to meet a preset requirement of first preset prediction index values for a consecutive preset number of times, removing the execution body from the power grid control model, or retraining the execution body through the power grid control model training data.

6. The power grid control model training method according to claim 1, further comprising:
acquiring power grid control model real-time data of an execution body with a second preset prediction index value less than a preset prediction requirement of second preset prediction index values to obtain data with a key feature; and sharing the data with the key feature as the power grid control model training data to the training data sets to obtain a plurality of updated training data sets;
training, according to one-to-one correspondences between the updated training data sets and the learning bodies, the plurality of preset learning bodies in parallel through the plurality of updated training data sets to obtain a plurality of updated execution bodies; and
replacing the plurality of execution bodies in the power grid control model with the plurality of updated execution bodies.

7. The power grid control model training method according to claim 6, wherein before training the plurality of preset learning bodies in parallel through the plurality of updated training data sets, the method further comprises:
acquiring relevant data of the data with the key feature, and sharing the relevant data of the data with the key feature as the power grid control model training data to the updated training data sets,
wherein the relevant data comprises at least one of data with a temporal relationship to the data with the key feature, data of a device with a topological connection relationship to a device corresponding to the data with the key feature, or data with a service logic relationship to the data with the key feature.

8. The power grid control model training method according to claim 6, wherein before training the plurality of preset learning bodies in parallel through the plurality of updated training data sets, the method further comprises:
extracting a feature of the data with the key feature through a data feature analysis method to obtain an extracted feature; and
acquiring an optimization approach, and optimizing power grid control model training data in the updated training data sets or the plurality of learning bodies according to the optimization approach, wherein the optimization approach is obtained according to the extracted feature in combination with a test evaluation effect of the learning bodies, an inference effect of the execution bodies and service domain knowledge, wherein the test evaluation effect of the learning bodies and the inference effect of the execution bodies are obtained in a manual analysis manner.

9. The power grid control model training method according to claim 8, wherein the optimization approach comprises one or more of:
changing a data range of the power grid control model training data, changing a data dimension of the power grid control model training data, changing a data checking rule of the power grid control model training data, changing a data cleaning rule of the power grid control model training data, and changing a number of the learning bodies.

10. The power grid control model training method according to claim 1, wherein fusing the outputs of the plurality of execution bodies into the output of the power grid control model comprises:
taking weighted superposition of the outputs of the plurality of execution bodies according to the preset weighting coefficients of the execution bodies as the output of the power grid control model; or processing the outputs of the plurality of execution bodies according to a scoring method to obtain the output of the power grid control model.

11. The power grid control model training method according to claim 10, further comprising: dynamically adjusting the preset weighting coefficients of the execution bodies at a dynamic frequency,
wherein the preset weighting coefficients of the execution bodies are adjusted by:
acquiring prediction accuracy rates or prediction precision rates of the execution bodies; and
adjusting the weighting coefficients of the execution bodies according to the prediction accuracy rates or the prediction precision rates of the execution bodies by using a factor analysis method, a principal component analysis method, an Analytic Hierarchy Process (AHP) method, a precedence graph method, an entropy method, a Criteria Importance Through Intercriteria Correlation (CRITIC) weighting method, an independence weighting method, or an information amount weighting method.

12-15. (canceled)

16. A computer device, comprising a memory and a processor, wherein the processor is configured to:
acquire and group power grid control model training data to obtain a plurality of training data sets, wherein the power grid control model training data is acquired from control big data based on different control service requirements, and the control big data big data is a collection of data associated with power grid operation, and comprises power grid model data, monitoring data, alarm data, and operation records;
train, according to one-to-one correspondences between the training data sets and learning bodies, a plurality of preset learning bodies in parallel through the plurality of training data sets to obtain a plurality of execution bodies; wherein when training the learning bodies through the training data sets, a current training data set is divided into a plurality of training data units, a current learning body is trained through the plurality of training data units in sequence, and training effects of the plurality of training data units on the current learning body are acquired; and a training data unit with a training effect meeting a preset training effect requirement is taken as a shared training data unit, and the shared training data unit is shared with training data sets except a training data set comprising the shared training data unit, wherein the plurality of learning bodies are a plurality of Artificial Intelligence (AI) models for a power grid control service constructed according to a power grid control requirement; and
combine the plurality of execution bodies to obtain a power grid control model, wherein the combining comprises taking inputs to the plurality of execution bodies together as an input to the power grid control model, and fusing outputs of the plurality of execution bodies into an output of the power grid control model,
wherein the power grid control service is bus load prediction or power grid device fault prediction.

17. A computer-readable storage medium, having stored thereon a computer program that, when executed by a processor, implements following operations:
acquiring and grouping power grid control model training data to obtain a plurality of training data sets, wherein the power grid control model training data is acquired from control big data based on different control service requirements, and the control big data big data is a collection of data associated with power grid operation, and comprises power grid model data. monitoring data, alarm data, and operation records;
training, according to one-to-one correspondences between the training data sets and learning bodies, a plurality of preset learning bodies in parallel through the plurality of training data sets to obtain a plurality of execution bodies; wherein when training the learning bodies through the training data sets, a current training data set is divided into a plurality of training data units, a current learning body is trained through the plurality of training data units in sequence, and training effects of the plurality of training data units on the current learning body are acquired; and a training data unit with a training effect meeting a preset training effect requirement is taken as a shared training data unit, and the shared training data unit is shared with training data sets except a training data set comprising the shared training data unit, wherein the plurality of learning bodies are a plurality of Artificial Intelligence (AI) models for a power grid control service constructed according to a power grid control requirement; and
combining the plurality of execution bodies to obtain a power grid control model, wherein the combining comprises taking inputs to the plurality of execution bodies together as an input to the power grid control model, and fusing outputs of the plurality of execution bodies into an output of the power grid control model,
wherein the power grid control service is bus load prediction or power grid device fault prediction.

18. The computer device according to claim 16, wherein the processor is further configured to:
train, according to the one-to-one correspondences between the training data sets and the learning bodies, the plurality of preset learning bodies in parallel through the plurality of training data sets in combination with preset evaluation bodies corresponding one-to-one to the learning bodies; and after the training is completed, acquire preset prediction indexes of the learning bodies via the evaluation bodies, and take learning bodies with preset prediction indexes meeting a preset training requirement for the preset prediction indexes as the execution bodies.

19. The computer device according to claim 16, wherein the plurality of AI models for the power grid control service are constructed via two or more machine learning algorithms or artificial intelligence algorithms.

20. The computer device according to claim 16, wherein the plurality of AI models for the power grid control service execute a same type of power grid control service or complementary power grid control services.

21. The computer device according to claim 16, wherein the processor is further configured to:
periodically acquire first preset prediction index values of the execution bodies in the power grid control model for power grid control model real-time data; and
when a first preset prediction index value of an execution body in the power grid control model fails to meet a preset requirement of first preset prediction index values for a consecutive preset number of times, remove the execution body from the power grid control model, or retrain the execution body through the power grid control model training data.

22. The computer device according to claim 16, wherein the processor is further configured to:
acquire power grid control model real-time data of an execution body with a second preset prediction index value less than a preset prediction requirement of second preset prediction index values to obtain data with a key feature; and share the data with the key feature as the power grid control model training data to the training data sets to obtain a plurality of updated training data sets;
train, according to one-to-one correspondences between the updated training data sets and the learning bodies, the plurality of preset learning bodies in parallel through the plurality of updated training data sets to obtain a plurality of updated execution bodies; and
replace the plurality of execution bodies in the power grid control model with the plurality of updated execution bodies.

23. The computer device according to claim 22, wherein the processor is further configured to:
acquire relevant data of the data with the key feature, and share the relevant data of the data with the key feature as the power grid control model training data to the updated training data sets,
wherein the relevant data comprises at least one of data with a temporal relationship to the data with the key feature, data of a device with a topological connection relationship to a device corresponding to the data with the key feature, or data with a service logic relationship to the data with the key feature.

24. The computer device according to claim 22, wherein the processor is further configured to:
extract a feature of the data with the key feature through a data feature analysis method to obtain an extracted feature; and
acquire an optimization approach, and optimize power grid control model training data in the updated training data sets or the plurality of learning bodies according to the optimization approach, wherein the optimization approach is obtained according to the extracted feature in combination with a test evaluation effect of the learning bodies, an inference effect of the execution bodies and service domain knowledge, wherein the test evaluation effect of the learning bodies and the inference effect of the execution bodies are obtained in a manual analysis manner.
